(19) United States
(12) Patent Application Publication
(10) Pub. No.: US 2019/0094816 A1
(43) Pub. Date: Mar. 28, 2019

(54) ASSEMBLABLE SMART WATCH

(71) Applicant: Sang Un Seong, Gyeonggi-do (KR)

(72) Inventor: Sang Un Seong, Gyeonggi-do (KR)

(21) Appl. No.: 16/009,457

(22) Filed: Jun. 15, 2018

(30) Foreign Application Priority Data
Sep. 22, 2017 (KR) 10-2017-0122684
Jun. 1, 2018 (KR) 10-2018-0063142

(51) Int. Cl. G04G 17/08; G04G 9/00; G04G 5/00; G04G 17/04; G04G 19/00

(52) U.S. Cl. CPC G04G 17/08; G04G 9/0064; G04G 19/00; G04G 17/045; G04G 5/00

(57) ABSTRACT

The present disclosure relates to an assemblable smart watch comprising: a main watch body configured to perform setting, selecting and driving of convenient functions including time, date, weather, and multimedia; a bezel removably coupled to an upper outer circumferential surface of the main watch body; a case member configured to allow: a watch strap to be replaced through both ends; the main watch body to be removably coupled to an upper portion; and a lower portion of the bezel to be seated thereon to improve hermetic properties; and a setting movement passed through the case member and removably coupled with the main watch body, the setting movement allowing the convenience functions to be selected and driven.

### CROSS-REFERENCE TO RELATED APPLICATION

This application claims priority of Korean Patent Application No. 10-2017-0122684, filed on Sep. 22, 2017, and priority of Korean Patent Application No. 10-2018-0063142, filed on Jun. 1, 2018, in the KIPO (Korean Intellectual Property Office), the disclosure of which is incorporated herein entirely by reference.

### BACKGROUND OF THE INVENTION

### Field of the Invention

The present disclosure relates to an assemblable smart watch, and more particularly, to an assemblable smart watch which allows parts of various designs and functions to be replaced and used therein according to the wearer's taste with a simple fastening method, and which significantly saves cost for a customer who can collect or wear expensive watches of respective designs by simply replacing parts with the corresponding parts of different designs.

### Description of the Related Art

Generally, the mobile terminal provides a wide range of functions such as data communication and voice communication, photographing and video shooting through a camera, voice recording, music file playback through a speaker system, and image or video output to a display, and so on.

In particular, smart watches are provided, which provide a variety of additional functions in interoperation with mobile terminals. Meanwhile, the mobile terminals generally have a rectangular display, but there are smart watches having a circular display which is similar in shape to the general analogue watches, and in recent years, smart watches, which are the wrist watch type mobile terminals, are increasingly in demand.

The smart watch is an embedded system wrist watch that is equipped with advanced functions than the general watches, and it can be installed with a mobile operating system to perform functions of a smart phone and is also applicable with various designs to express user's individuality.

For example, Korean Patent Publication No. 10-2017-0027929 discloses a smart watch comprising a display panel including a body having a polygonal shape, and a corner extending and bent from at least one side of the body; and a housing disposed under the display panel and having an area smaller than a sum of the area of the body and the area of the corner, in which the corner is defined by the at least one side of the body and sides joined by the other sides of the body connected to the at least one side of the body and extending therefrom respectively.

However, such conventional smart watch realizes a circular display by simply bending a portion of the display panel having a usual polygonal shape and it implements a circular smart watch using a process of fabricating a conventional polygonal display panel instead of a process of fabricating a circular display panel. Accordingly, it is difficult to provide customers with smart watches of various designs.

### SUMMARY OF THE INVENTION

In order to solve the problems occurring in the art mentioned above, the present disclosure has been made to provide an assemblable smart watch which allows to replace and use smart watch with various designs and functions according to the wearer's taste by a simple fastening method.

In addition, it is an object of the present disclosure to provide an assemblable smart watch capable of significantly saving cost for a customer who can collect or wear expensive watches of respective designs by simply replacing parts with the corresponding parts of different designs.

However, it should be understood that the scope of the present disclosure is not limited thereto and that, even if not explicitly mentioned herein, the objects and effects which can be understood from the means for solving the problems and the embodiments of the present disclosure are also included therein.

In order to achieve the objective mentioned above, according to an embodiment of the present disclosure, an assemblable smart watch includes is provided, which may include: a main watch body configured to perform setting, selecting and driving of convenient functions including time, date, weather, and multimedia; a bezel removably coupled to an upper outer circumferential surface of the main watch body; a case member configured to allow: a watch strap to be replaced through both ends; the main watch body to be removably coupled to an upper portion; and a lower portion of the bezel to be seated thereon to improve hermetic properties; a setting movement passed through the case member and removably coupled with the main watch body, the setting movement allowing the convenience functions to be selected and driven.

According to one embodiment of the present disclosure, the assemblable smart watch may further include: a power supply member removably coupled to a lower surface; and a trigger which connects the power supply member to the main watch body.

According to one embodiment of the present disclosure, the main watch body may further include: a control board which interoperates with the mobile terminal and controls such that the convenience functions are outputted according to whether the setting movement is operated or not; a display which outputs the convenience functions under the control of the control board; and a watch housing having the control board mounted therein, and the display coupled with an upper surface thereof, the watch housing being removably coupled with the case member.

According to one embodiment of the present disclosure, the watch housing may further include: a mount formed along an upper outer circumferential surface to allow the bezel to be coupled; a plurality of guide grooves formed on an outer circumferential surface such that a display position of the display is formed at a fixed position when the guide groove is coupled with the case member; a fastening groove fastened with a fastening means passed through the case member; a connecting part formed on one side or both sides of the fastening groove, respectively, for establishing electrical connection between the setting movement and the control board; a coupling part protruding from a lower outer circumferential surface and having a first coupling groove along an outer circumferential surface and a second coupling groove extending perpendicularly from an upper end of the first coupling groove.

According to one embodiment of the present disclosure, the case member may further include: a connecting elevation on which a lower portion of the bezel is seated; a through hole formed such that a fastening means for coupling the main watch body and the case member, and the setting movement are passed therethrough; a fixing groove on an inner circumferential surface for fixing the coupling plate.

According to one embodiment of the present disclosure, the case member may further include: a coupling plate for restricting coupling of the main watch body to a predetermined direction only, and for supporting the main watch body and the case member to be firmly coupled with each other.

According to one embodiment of the present disclosure, the bezel may further include: a mounting guide projection removably coupled to the main watch body; a hermetic flange formed with the mounting guide projection on the inner surface and seated on an upper surface of the case member; and a numerical indicator in which a graduated ruler is formed on an upper inner circumferential surface.

According to the embodiment of the present disclosure described above, it is possible to replace and use smart watch having various designs and functions according to the wearer's taste by a simple fastening method, and there is an effect that various watch designs that go well with the dress style intended by the customer can be realized.

In addition, according to embodiments of the present disclosure, there is an effect that an assemblable smart watch is capable of significantly saving cost for a customer who can collect or wear expensive watches of respective designs by simply replacing parts with the corresponding parts of different designs.

Further, the various and beneficial advantages and effects of the present disclosure are not limited to those described above and can be more easily understood in the course of describing a specific embodiment of the present disclosure.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is an exploded perspective view showing an assemblable smart watch according to one embodiment of the present disclosure;

FIG. 2 is a perspective view showing a coupled state of assemblable smart watch according to one embodiment of the present disclosure;

FIG. 3 is a view showing a main watch body of an assemblable smart watch according to one embodiment of the present disclosure;

FIG. 4 is a cross-sectional view schematically showing a main watch body of an assemblable smart watch according to one embodiment of the present disclosure;

FIG. 5 is a view showing a bottom portion of a bezel according to one embodiment of the present disclosure;

FIG. 6 is an exploded perspective view showing a case member of an assemblable smart watch according to one embodiment of the present disclosure; and

FIGS. 7 to 10 are views showing an assembling process of an assemblable smart watch according to one embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

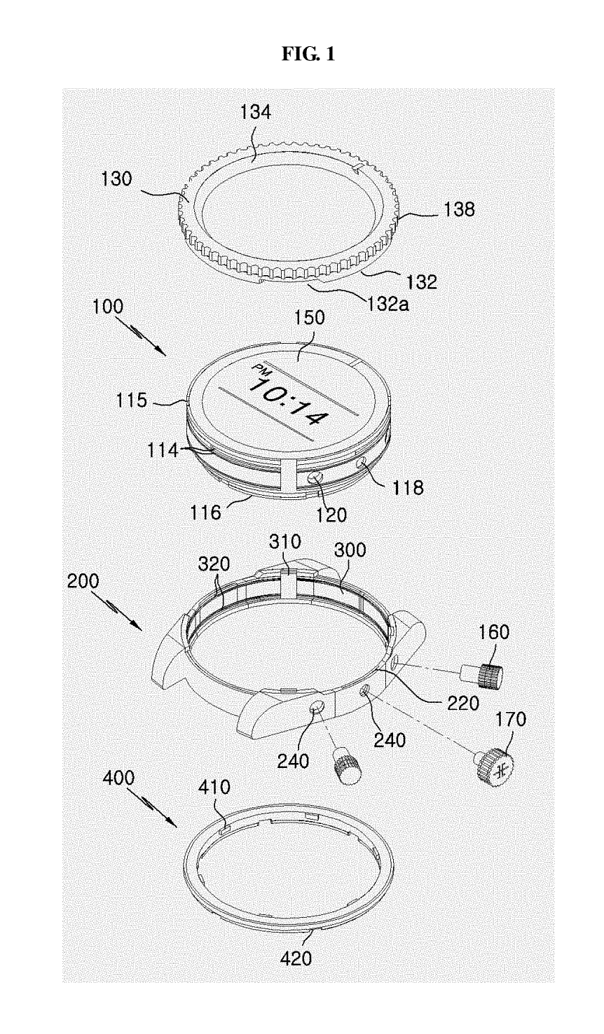

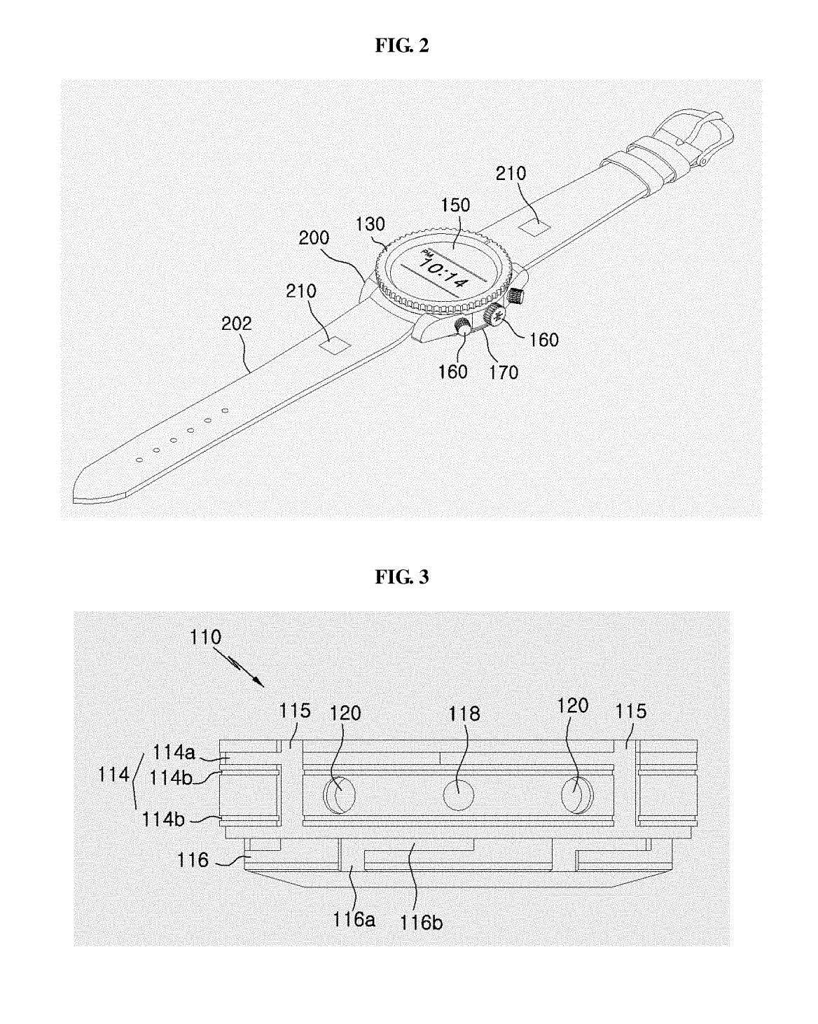

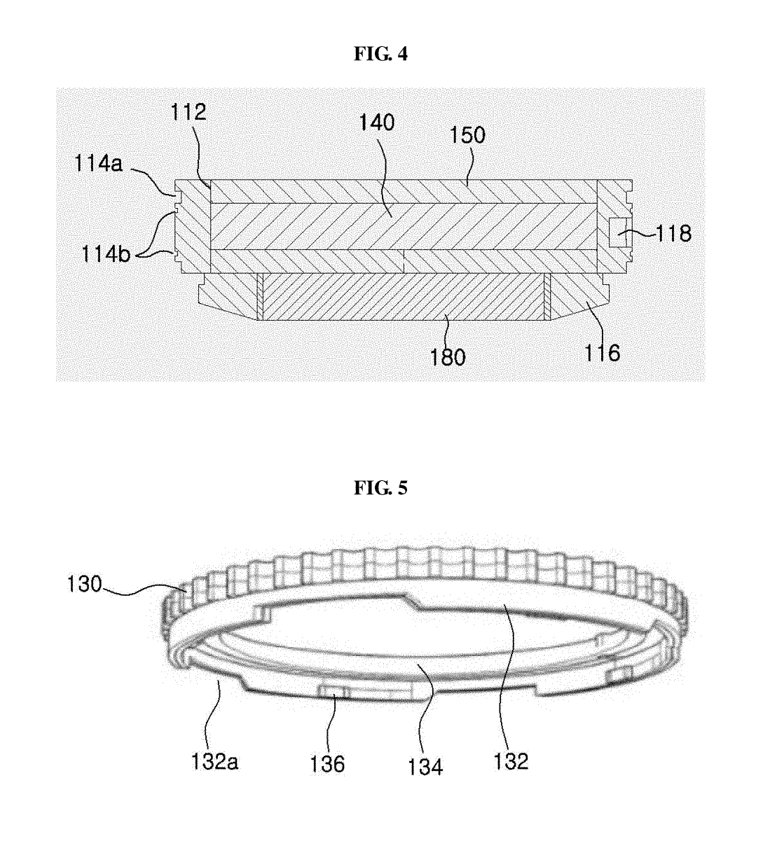

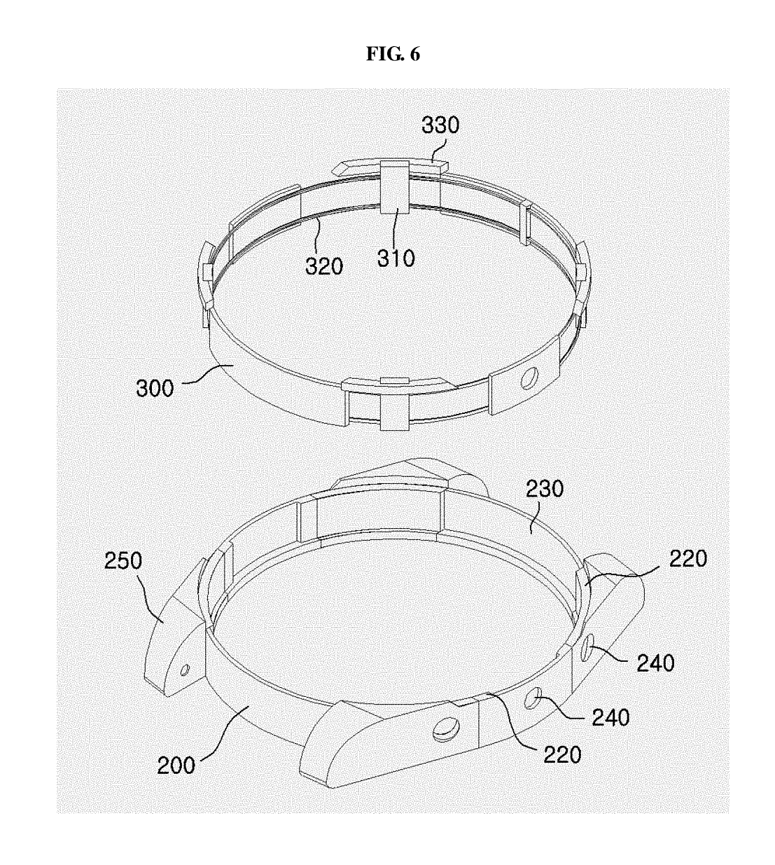

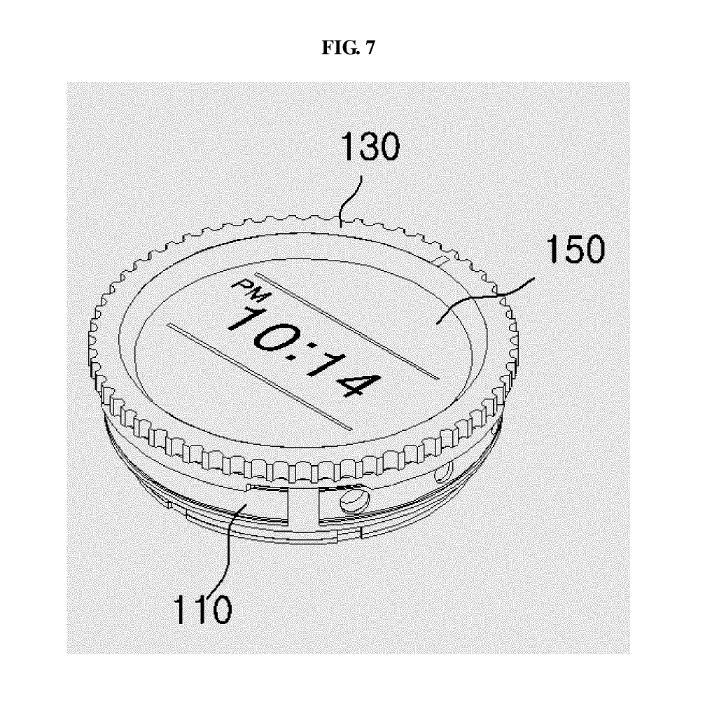

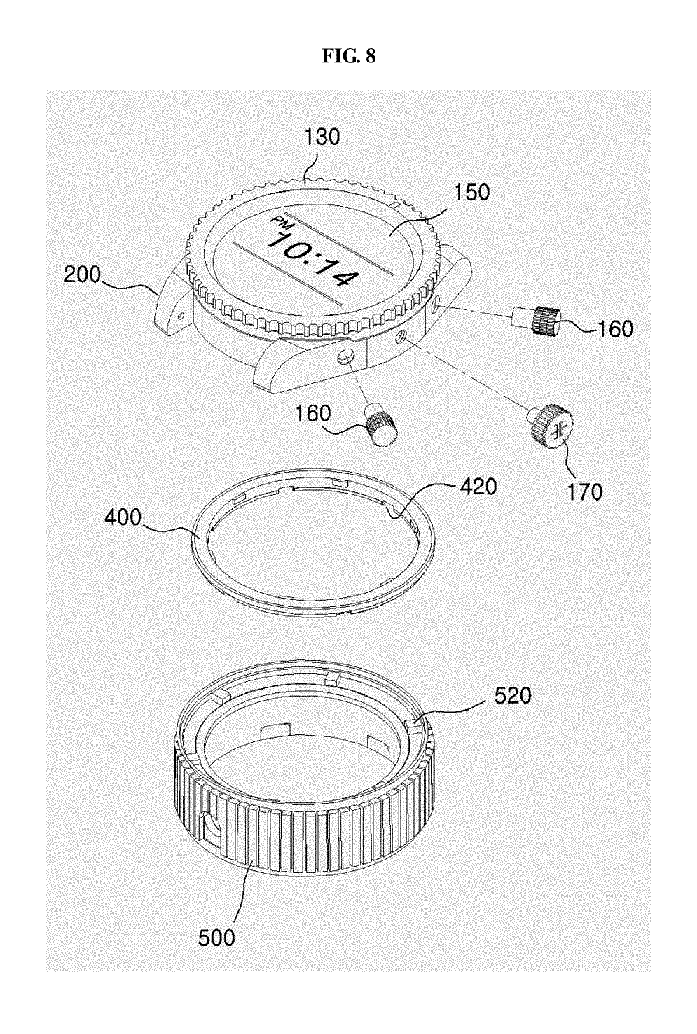

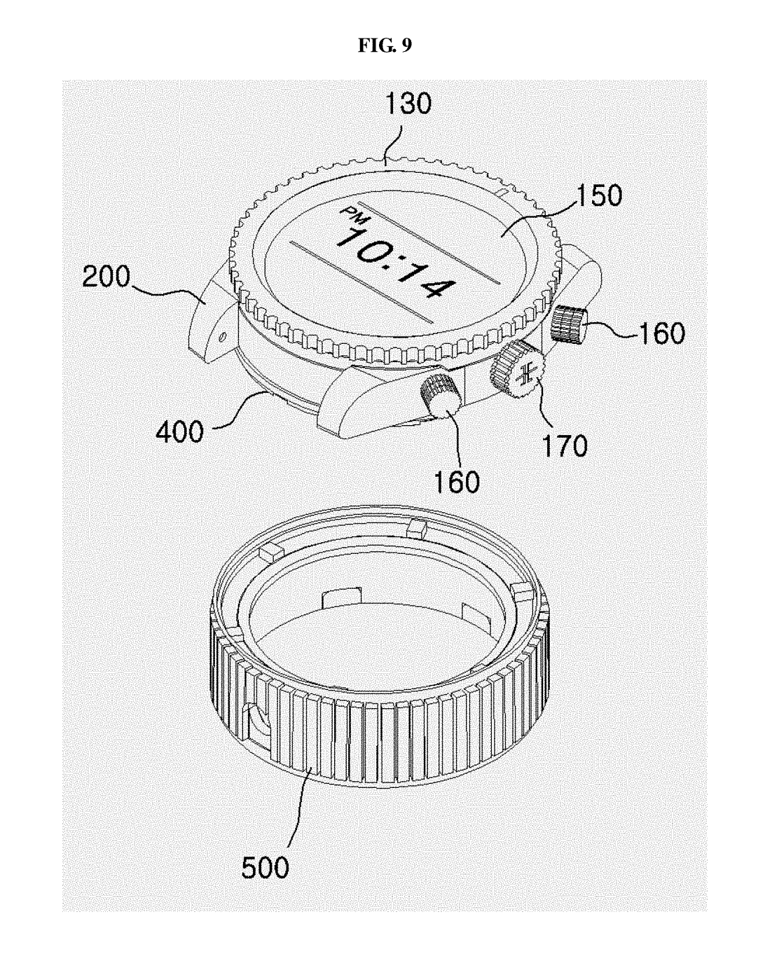

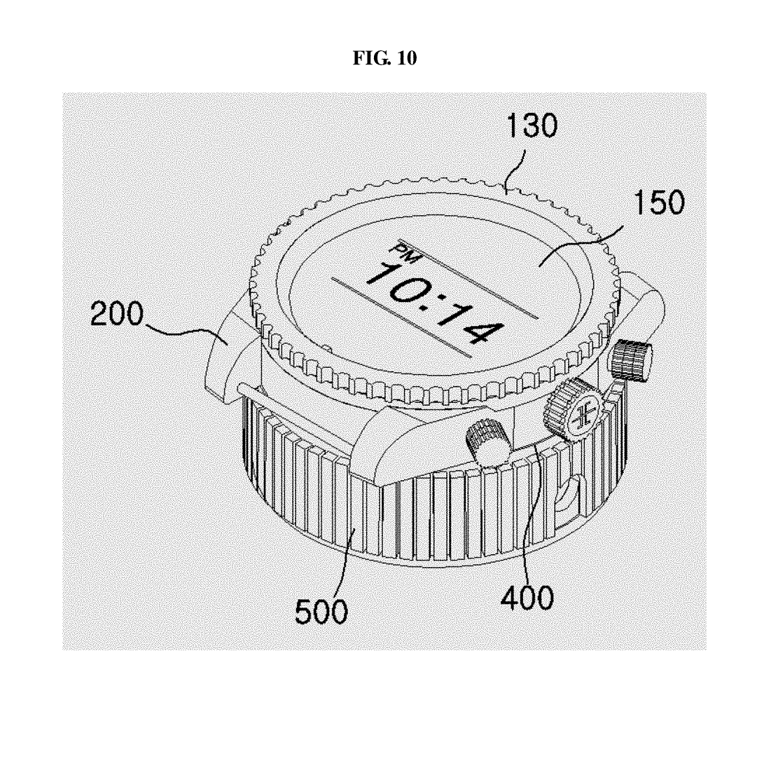

FIGS. 1 and 2 are perspective views showing an assemblable smart watch according to one embodiment of the present disclosure, FIGS. 3 and 4 are views showing a main watch body of an assemblable smart watch according to one embodiment of the present disclosure, FIG. 5 is a view showing a bottom portion of a bezel according to one embodiment of the present disclosure, FIG. 6 is an exploded perspective view showing a case member of an assemblable smart watch according to one embodiment of the present disclosure, and FIGS. 7 to 10 are views showing an assembling process of an assemblable smart watch according to one embodiment of the present disclosure.

As illustrated, an assemblable smart watch according to the present disclosure includes a main watch body 100, a case member 200, a coupling plate 300, and a trigger 400.

The main watch body 100 is removably coupled to the case member 200 and is configured to output time information and functions provided from various applications.

In this example, various applications may include health information, weather, and location information providing applications, or multimedia service providing applications providing music, moving picture, and image information, which are installed on a mobile terminal such as a smart phone.

The main watch body 100 includes a watch housing 110, a connecting part 120, a bezel 130, a control board 140, a display 150, a setting movement 160 and a fastening means 170.

The watch housing 110 is formed in a shape of an enclosure having an open upper end, configured such that the control board 140 is mounted therein, and has an insertion groove 112 provided for the display 150 to be mounted to the open upper end.

In this example, the insertion groove 112 is open through one lower surface thereof, and there further is a connection plate 180 electrically connected to both the power supply member 500 and the control board 140 such that power necessary for driving the smart watch is supplied from the power supply member 500 to the control board 140 by the connection plate 180.

In addition, the watch housing 110 is provided with a mount 114 on the outer upper thereof, which allows the bezel 130 and the coupling plate 300 of the case member 200 to be removably mounted thereon.

The mount 114 is formed along an upper outer circumferential surface of the watch housing 110 so that the bezel 130 is coupled with the watch housing 110, and composed of a first mounting groove 114a into which a mounting guide projection 136 formed in the bezel 130 is inserted and fixed, and a plurality of second mounting grooves 114b which are formed at a predetermined interval under the first mounting groove 114a and into which a mounting projection 320 of the coupling plate 300 is inserted and fixed such that the case member 200 is coupled to the watch housing 110.

The watch housing 110 is further provided with a guide groove 115 formed on an outer circumferential surface thereof perpendicularly to an axial direction of the main watch body 100. There may be a plurality of guide grooves formed at a predetermined interval or at 90-degree interval along the outer circumferential surface of the watch housing 110.

The guide groove 115 is provided to receive a guide projection 310 formed on the coupling plate 300 therein which is slidably moved from the upper to the lower sides when the main watch body 100 is coupled to the case member 200, thus constantly holding the display 150 at a certain position.

Accordingly, when a user attempts to couple the main watch body 100 of the design desired by the user to the case member 200, the possibility of assembling in an incorrect direction with respect to the upper and lower sides of the display 150 is prevented, and the user is accordingly prevented from experiencing inconvenience of having to repeat the process of un-assembling and re-assembling the main watch body 100. Accordingly, the user is enabled to easily perform the assembling process of the smart watch of the present disclosure.

In addition, the watch housing 110 has fastening grooves 118 formed between a plurality of second mounting grooves 114b and fastened with the fastening means 170 to provide a more secure engagement between the watch housing 110 and the case member 200.

In addition, the watch housing 110 has connecting parts 120 which are formed at a predetermined interval on one or both sides of the fastening groove 118 and which are passed through, and which provide an electrical connection between the setting movement 160 and the control board 140.

In this example, the setting movement 160 is provided to select or drive various functions such as time, date, weather, multimedia, and so on of the smart watch outputted through the display 150 and may be coupled with at least one of the connecting parts 120.

In this example, the connecting part 120 may be provided with a signal transmission means such as a connection terminal for transmitting a signal corresponding to an amount of rotation or a direction of rotation of the setting movement 160 to the control board 140, in which case it is possible to adjust the time or to select and drive various applications provided in the smart watch, by the operation of the setting movement 160.

Further, the watch housing 110 of the present disclosure may be further provided with a coupling part 116 at a lower end, to which a trigger 400 is removably coupled to maintain the connection of the main watch body 100 with the case member 200, or to provide a connection between the power supply member 500 and the main watch body 100.

The coupling part 116 extends downward from a lower end of the watch housing 110 and protrudes to pass through the case member 200 and be removably coupled with the power supply member 500.

Such coupling part 116 includes a first coupling groove 116a into which a coupling projection 410 formed on the trigger 400 is inserted to removably couple the coupling part 116 with the power supply member 500 and the trigger 400, and a second coupling groove 116b extending perpendicularly from an upper end of the first coupling groove 116a into which the coupling projection 410 is slidably moved and fixed in position.

Although the watch housing 110 is described as having a circular shape in the present disclosure, the present disclosure is not limited thereto, and accordingly, the watch housing 110 may have a shape of polygon such as square, and so on.

The bezel 130 is removably and rotatably coupled to a first mounting groove 114a of the watch housing 110 and is configured to enclose an upper surface of the main watch body 100.

In order to be mated with the watch housing 110, the bezel 130 includes a mounting guide projection 136 to be inserted into the first mounting groove 114a, and a plurality of hermetic flanges 132 extending downward from a lower surface and formed at a predetermined interval along a circumferential surface of bezel 130, in which the predetermined interval may be an equal interval.

The hermetic flanges 132 are configured to prevent the foreign matter from penetrating into a gap between the outer surface of the watch housing 110 and the inner surface of the case member 200 by being seated on a connecting elevation 220 formed on the upper surface of the case member 200.

In this example, the hermetic flange 132 may be provided with the mounting guide projection 136 on an inner circumferential surface such that the bezel 130 and the watch housing 110 are coupled with each other, and at the same time, the watch housing 110 and the case member 200 are maintained hermetic.

In addition, the bezel 130 may also be provided with a support projection 138 on an outer circumferential surface thereof to allow the user to easily rotate the bezel 130, although the present disclosure is not limited thereto.

In addition, the bezel 130 may have a numerical indicator 134 having a graduated ruler or the like formed on an inner circumferential surface, although the present disclosure is not limited thereto.

The control board 140 is configured to communicate with a mobile terminal such as a smartphone, a tablet PC, and so on, and is a component to control according to an operation of the setting movement 160 such that the display 150 not only displays the time, but also outputs a variety of convenience functions such as photographing or video shooting, music or video file playback, games, and so on.

In addition, the control board 140 may further include a connection plate for receiving power necessary to drive the smart watch, and the connection plate may be configured to be charged by a wired or wireless method.

Of course, the control board 140 may be installed with a mobile operating system, and accordingly, like a smart phone, the smart watch is configurable to independently drive a variety of applications.

The display 150 not only displays time, but also outputs a variety of convenient functions such as photographing or video shooting, music or video file, a game, etc. according to the control of the control board 140.

The display 150 may be a conventional touch screen and may be configured such that the user is enabled to directly control driving of the application outputted through the display 150 by touching an icon of the application.

Although the main watch body 100 of the present disclosure is shown as having a circular shape in the drawings, embodiments are not limited thereto, and accordingly, may be formed in a shape of a polygon. Further, the watch housing 110 and the bezel 130 may be formed in various colors to enable the user to easily change the shape and design that suit the taste or the dress concept of the user (wearer).

The case member 200 is removably coupled to the main watch body 100, electrically connected to the power supply member 500 of the main watch body 100 and includes connecting flanges 250 on both ends to allow replacement of a watch strap 202.

The case member 200 is also provided with a plurality of connecting elevations 220 at a predetermined interval along an upper circumferential surface, on which the hermetic flanges 132 of the bezel 130 are seated and coupled.

In addition, the case member 200 includes a plurality of through holes 240 formed on the same center line as the fastening groove 118 and the connecting part 120 such that the setting movement 160 and the fastening means 170 are passed through one side of the case member 200, respectively, and coupled with the watch housing 110.

The case member 200 further includes a coupling plate 300 formed on an inner circumferential surface thereof to support the watch housing 110 to be removably coupled to the case member 200 and has a fixing groove 230 which fixes the coupling plate 300 in position.

In this example, the coupling plate 300 restricts coupling of the main watch body 100 to a predetermined direction only when the main watch body 100 is coupled, thus preventing a situation that the convenience functions from being displayed through the display 150 in a reversed direction. At the same time, the coupling plate 300 also serves to support the main watch body 100 and the case member 200 to remain in a firm coupling state, thereby preventing the main watch body 100 from being accidentally separated from the case member 200.

The coupling plate 300 includes a guide projection 310 to be inserted into a guide groove 115 formed in the watch housing 110 to fixing the watch housing 110 in the coupled position, and a mounting projection 320 coupled with the second mounting groove 114b in a fitting method to couple the watch housing 110 to the case member 200.

In addition, the coupling plate 300 may further include an insert elevation 330 on an upper surface to further increase the hermetic condition between the main watch body 100 and the case member 200, by being inserted into a hermetic groove 132a formed between the hermetic flanges 132 of the bezel 130.

Meanwhile, in some embodiments of the present disclosure, the watch strap 202 may be embedded with a multi-function sensor 210 in contact with the wearer's wrist to sense the health information of the wearer or the hand movements of the wearer and transmit the sensed result to the control board 140 by a near field wireless communication so that the sensed result is outputted (indicated) through the display 150.

In an example, the multi-function sensor 210 may be any of a heart rate sensor for measuring the heart rate of the wearer, a pedometer for measuring the number of steps the wearer has made on foot, a body temperature sensor for measuring the body temperature of the wearer, a sweat component measuring sensor for measuring the sweat components of the wearer, and a motion detection sensor for sensing the movement of the wearer's hand, but not limited thereto.

The trigger 400, with its upper inner circumferential surface of the trigger 400 being coupled to the coupling part 116 formed on the lower portion of the watch housing 110, and with its lower inner circumferential surface of the trigger 400 being removably coupled to the power supply member 500, allows connection between the main watch body 100 and the power supply member 500.

The trigger 400 includes a coupling projection 410 formed on the upper inner circumferential surface thereof to be coupled with the first and second coupling grooves 116a and 116b formed in the coupling part 116, and a power connecting part 420 formed on the lower inner circumferential surface thereof, to which the power supply member 500 is removably coupled.

In this example, the coupling projection 410 is removably coupled with the first and second coupling grooves 116a and 116b while being rotated by a certain range by the power supply member 500.

In addition, the power connecting part 420 may be formed in a flange shape, in which case a plurality of grooves may be formed at a predetermined interval such that the power supply member 500 is fitted to the groove portion, although the embodiments are not limited thereto.

Since the trigger 400 is configured such that the upper surface thereof is in close contact with the lower surface of the case member 200 as the trigger 400 is coupled with the coupling part 116 forming the lower portion of the main watch body 100, the main watch body 100 can be prevented from being separated from the case member 200 even when the main watch body 100 is accidentally disconnected from the coupling plate 300.

That is, the trigger 400 serves as a nut for fixing the main watch body 100 to the case member 200.

The power supply member 500 may be provided with a charging terminal that is connected to the coupling part 116 of the watch housing 110 by the trigger 400, to supply and also charge a power.

In addition to the function of supplying and charging power, the power supply member 500 also performs a function of supporting a tight coupling between the trigger 400 and the main watch body 100 such that the main watch body 100 and the case member 200 are connected and disconnected.

That is, the power supply member 500 has a tool fixing member 520 configured in the form of a projection on the upper portion of the power supply member 500 and coupled with the power connecting part 420 of the trigger 400 such that the power supply member 500 provides coupling and separating the trigger 400 and the main watch body 100 as the coupling projection 410 configured on the trigger 400 is inserted into the first coupling groove 116a, and then as the trigger 400 is rotated toward the second coupling groove 116b to cause the coupling projection 410 to be fixed in the second coupling groove 116b.

Accordingly, the assemblable smart watch according to the present disclosure does not require use of a separate fastening tool or the like for separating and coupling each of the components, but instead uses the power supply member 500 to fulfill a function of an assembling tool and a fastening tool, or the like, which can enable more efficient and convenient assembling and disassembling process, while also preventing deterioration of the coupling force due to a clearance on the coupling part that may be generated over repeated assembling and disassembling processes.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An assemblable smart watch comprising:
a main watch body configured to perform setting, selecting and driving of convenient functions including time, date, weather, and multimedia;
a bezel removably coupled to an upper outer circumferential surface of the main watch body;
a case member configured to allow:
a watch strap to be replaced through both ends;
the main watch body to be removably coupled to an upper portion; and
a lower portion of the bezel to be seated thereon to improve hermetic properties; and
a setting movement passed through the case member and removably coupled with the main watch body, the setting movement allowing the convenience functions to be selected and driven.

2. The assemblable smart watch of claim 1, wherein the main watch body further comprises:
a power supply member removably coupled to a lower surface;
a trigger which connects the power supply member to the main watch body;
a control board which interoperates with the mobile terminal and controls such that the convenience functions are outputted according to whether the setting movement is operated or not;
a display which outputs the convenience functions under the control of the control board; and
a watch housing having the control board mounted therein, and the display coupled with an upper surface thereof, the watch housing comprising:
a mount formed along an upper outer circumferential surface to be coupled with the bezel for removable coupling with the case member;
a plurality of guide grooves formed on an outer circumferential surface such that a display position of the display is formed at a fixed position when the guide groove is coupled with the case member;
a fastening groove fastened with a fastening means passed through the case member;
a connecting part formed on one side or both sides of the fastening groove, respectively, for establishing electrical connection between the setting movement and the control board; and
a coupling part protruding from a lower outer circumferential surface and having a first coupling groove along an outer circumferential surface and a second coupling groove extending perpendicularly from an upper end of the first coupling groove.

3. The assemblable smart watch of claim 1, wherein the case member further comprises:
a connecting elevation on which a lower portion of the bezel is seated;
a through hole formed such that a fastening means for coupling the main watch body and the case member, and the setting movement are passed therethrough;
a fixing groove on an inner circumferential surface for fixing the coupling plate; and
a coupling plate for restricting coupling of the main watch body to a predetermined direction only, and for supporting the main watch body and the case member to be firmly coupled with each other.

4. The assemblable smart watch of claim 1, wherein the main watch body further comprises:
a power supply member removably coupled to a lower surface;
a trigger which connects the power supply member to the main watch body;
a control board which interoperates with the mobile terminal and controls such that the convenience functions are outputted according to whether the setting movement is operated or not;
a display which outputs the convenience functions under the control of the control board; and
a watch housing having the control board mounted therein, and the display coupled with an upper surface thereof.

5. The assemblable smart watch of claim 4, wherein the case member further comprises:
a connecting elevation on which a lower portion of the bezel is seated;
a through hole formed such that a fastening means for coupling the main watch body and the case member, and the setting movement are passed therethrough;
a fixing groove on an inner circumferential surface for fixing the coupling plate; and
a coupling plate for restricting coupling of the main watch body to a predetermined direction only, and for supporting the main watch body and the case member to be firmly coupled with each other.
